(19) United States
(12) Patent Application Publication
(10) Pub. No.: US 2012/0254216 A1
(43) Pub. Date: Oct. 4, 2012

(54) INPUT SUPPORT DEVICE

(75) Inventors: Takeyuki Aikawa, Tokyo (JP); Takashi Mikami, Tokyo (JP); Hiroyuki Washino, Tokyo (JP); Atsushi Matsumoto, Tokyo (JP); Wataru Yamazaki, Tokyo (JP)

(73) Assignee: MITSUBISHI ELECTRIC CORPORATION, Tokyo (JP)

(21) Appl. No.: 13/515,343

(22) PCT Filed: Dec. 3, 2010
(86) PCT No.: PCT/JP2010/071682

§ 371 Date: Jun. 12, 2012

(30) Foreign Application Priority Data
Dec. 14, 2009 (JP) 2009-282967

(51) Int. Cl. G06F 17/30

(52) U.S. Cl. 707/758; 707/E17.014

(57) ABSTRACT

An input support device, including: a keyword dictionary for storing a keyword including one or more words; a candidate search mechanism searching entries within the keyword dictionary by using a search key including one or more words specified based on a user operation; a presentation candidate generation mechanism generating a presentation candidate list based on search results from the candidate search mechanism by extracting a word break mismatching presentation candidate from the keywords whose word break does not match that of the specified search key including the one or more words and which start with the specified search key including the one or more words; and a candidate display displaying the presentation candidate list generated by the presentation candidate generation mechanism.

### TECHNICAL FIELD

The present invention relates to an input support device for presenting candidates for a search keyword only by inputting a phonetic rendering by a several characters in order to efficiently input a keyword for a search or the like in equipment such as a car navigation system or a display device for FA.

### BACKGROUND ART

With the advance of various kinds of electronic equipment having higher functionalities, needs for viewing/searching of electronic manuals and the like on the equipment have grown. Further, from the aspect of environmental issues, needs for converting a conventional paper manual into an electronic format are large. In addition, a search function is essential in the equipment that uses a vast amount of content for a facility name search in destination setting of a car navigation system. However, there is a problem that the equipment including no keyboard makes it difficult to input a keyword for a search and requires time and labor in operation, thereby failing to sufficiently making use of a digitized document on the equipment. Therefore, as a technology for reducing the time and labor in input operation, JP 2008-242817 A entitled “Character input device and character input program” (Patent Literature 1) discloses a technology capable of improving efficiency of character input operation by predicting a desired character string to be continuously input by a user based on a character input by the user and screening prediction candidates based on the already-input character.

### CITATION LIST

### Patent Literature

[PTL 1]: JP 2008-242817 A entitled “Character input device and character input program”

### SUMMARY OF INVENTION

### Technical Problem

However, according to the conventional Patent Literature 1, no consideration is given to ambiguity of a word break. Therefore, in a case where a break pattern of a word which is registered in a phrase dictionary built into the electronic equipment differs from a break pattern of the word which is employed when a user inputs the word, there has been a problem in that a candidate intended by the user, in other words, the word with the break pattern employed by the user inputting the word, is not registered in the phrase dictionary, which requires time and labor in the inputting. For example, in a case of inputting “KANAZAWAHAKKEISOUGOUHOKENJIMUSHO”, which is registered as “KANAZAWAHAKKEI/SOUGOUHOKENJIMUSHO” in the phrase dictionary, as a destination of the car navigation system, even when the user attempts to input the phrase in chunks: “KANAZAWA/HAKKEI/SOUGOU/HOKENJIMUSHO”, no predictive conversion is performed if the break “KANAZAWA/HAKKEI” is not included in the phrase dictionary, which necessitates the inputting using another means such as kana-kanji conversion. An intended predictive conversion result is obtained if all those break patterns are registered in the phrase dictionary, but there are enormous combinations thereof, and hence the phrase dictionary becomes extremely large and hard to be built into normal electronic equipment.

Further, according to the conventional Patent Literature 1, no consideration is given to a phrase exhibiting ambiguity in part of its representation. Therefore, in a case where the user selects a representation different from a representation of a word registered in the phrase dictionary, there is a problem in that a predictive conversion result intended by the user is not obtained. For example, in a case of inputting “YOKOHAMAAISUKOUBOU” as the destination of the car navigation system, there is a problem in that the predictive conversion is not performed for “AISUKOUBOU” when the user erroneously selects the candidate “YOKOHAMA”.

The present invention has been made in order to solve the problems as described above, and an object thereof is to improve operability in predictive conversion by considering ambiguity of a word break in the predictive conversion to present prediction candidates expected by a user even if a break pattern of a word which is registered in a dictionary differs from a break pattern of the word which is employed when the user inputs the word.

Another object thereof is to improve the operability by considering a phrase exhibiting ambiguity in part of its representation to present a predictive conversion result intended by the user even in a case where the user selects a representation different from a representation of a word registered in the dictionary.

### Solution to Problem

According to the present invention, there is provided an input support device, which presents, when a phonetic rendering is input, words of a predictive keyword, which is obtained by separating a keyword that starts with the phonetic rendering by a word break, as candidates in units of breaks and which allows the keyword to be input hierarchically while selecting presented candidate words, the input support device including:

input means for receiving a phonetic rendering character string input by a user or a selection result of a presentation candidate word;

storage means in which the input means records the input phonetic rendering character string or the selection result of the presentation candidate word, which have been received, as a phonetic rendering character string;

a keyword dictionary including a phonetic rendering, a break of the phonetic rendering, a representation corresponding to the phonetic rendering, and a break of the representation corresponding to the break of the phonetic rendering;

candidate search means for searching, based on a phonetic rendering input by the user, the storage means for a phonetic rendering character string that follows the input phonetic rendering, and searching the keyword dictionary for presentation candidates based on the retrieved phonetic rendering character string;

word break matching candidate generation means for generating a presentation candidate list whose word break matches the selection result selected by the user in process of screening candidates based on search results from the candidate search means;

word break matching candidate count determination means for determining whether or not a number of elements within the presentation candidate list generated above is less than a maximum number of candidates that can be displayed on a screen;

word break mismatching candidate generation means for extracting, when a result from the word break matching candidate count determination means is less than the maximum number of candidates that can be displayed, a keyword candidate whose phonetic rendering matches that of the selection result selected by the user in the process of screening the candidates even if the word break differs therefrom, adding the keyword candidate to a word break matching presentation candidate list to generate the presentation candidate list; and

candidate display means for displaying the presentation candidate list,

in which the candidate search means further selects a candidate word from the presentation candidate list displayed by the candidate display means, and stores the candidate word in the storage means.

According to the present invention, there is provided another input support device, which presents, when a phonetic rendering is input, words of a predictive keyword, which is obtained by separating a keyword that starts with the phonetic rendering by a word break, as candidates in units of breaks and which allows the keyword to be input hierarchically while selecting presented candidate words, the input support device including:

input means for receiving a phonetic rendering character string input by a user or a selection result of a presentation candidate word;

storage means in which the input means records the input phonetic rendering character string or the selection result of the presentation candidate word, which have been received, as a phonetic rendering character string;

a keyword dictionary including a phonetic rendering, a break of the phonetic rendering, a representation corresponding to the phonetic rendering, and a break of the representation corresponding to the break of the phonetic rendering;

candidate search means for searching, based on a phonetic rendering input by the user, the storage means for a phonetic rendering character string that follows the input phonetic rendering, and searching the keyword dictionary for presentation candidates based on the retrieved phonetic rendering character string;

representation matching candidate generation means for generating a presentation candidate list whose representation matches the selection result selected by the user in process of screening candidates based on search results from the candidate search means;

representation matching candidate count determination means for determining whether or not a number of elements within the presentation candidate list generated above is less than a maximum number of candidates that can be displayed on a screen;

representation mismatching candidate generation means for extracting, when a result from the representation matching candidate count determination means is less than the maximum number of candidates that can be displayed, a presentation candidate whose phonetic rendering matches that of the selection result selected by the user in the process of screening the candidates but whose representation of the word partially differs therefrom, extracting words following the selection result in a score order, adding the words to a representation matching presentation candidate list to generate the presentation candidate list; and

candidate display means for displaying the presentation candidate list,

in which the candidate search means further selects a candidate word from the presentation candidate list displayed by the candidate display means, and stores the candidate word in the storage means.

### Advantageous Effects of Invention

An input support device according to the present invention has a configuration in which: a phonetic rendering character string input by a user or a selection result of a presentation candidate is received through input means and stored in storage means; candidate search means searches a keyword dictionary for a presentation candidate by using a phonetic rendering based on the input or the selected presentation candidate, the keyword dictionary including a phonetic rendering, a break of the phonetic rendering, a representation corresponding to the phonetic rendering, and a break of the representation corresponding to the break of the phonetic rendering; word break matching candidate generation means generates a presentation candidate list whose word break matches the selection result in process of screening candidates based on search results; word break matching candidate count determination means determines whether or not the number of elements within the presentation candidate list is less than a maximum number that can be displayed; word break mismatching candidate generation means extracts, when a result thereof is less, a candidate whose phonetic rendering matches that of the selection result in the process of screening the candidates but whose word break differs therefrom, cuts out a representation character string following the selection result in the process of the screening from within the representation character string of the same candidate, and adds the cut-out representation character string to the presentation candidate list; and display means displays the presentation candidate list. Accordingly, when the phonetic rendering matches even if the word break differs from that of the keyword dictionary, the candidate display means presents the word as the presentation candidate list, and hence it is possible to obtain the effect that the operability in the predictive conversion can be improved by presenting the prediction candidates expected by the user even if the break pattern of the word at the time when the user inputs the word differs from the break pattern of the word registered in the dictionary.

Further, another input support device according to the present invention has a configuration in which: a phonetic rendering character string input by a user or a selection result of a presentation candidate is received through input means and stored in storage means; candidate search means searches a storage unit for a phonetic rendering character string following the input phonetic rendering, and searches a keyword dictionary for a presentation candidate based on the phonetic rendering character string, the keyword dictionary including a phonetic rendering, a break of the phonetic rendering, a representation corresponding to the phonetic rendering, and a break of the representation corresponding to the break of the phonetic rendering; representation matching candidate generation means generates a presentation candidate list whose representation matches the selection result selected by the user in process of screening candidates based on search results; representation mismatching candidate generation means extracts in a score order, when it is determined by representation matching candidate count determination means that the number of elements within the presentation candidate list is less than a maximum number of candidates that can be displayed on a screen, presentation candidates whose phonetic renderings match that of the selection result in the process of screening the candidates but whose representations of the words partially differ therefrom, and adds the presentation candidates to a representation matching presentation candidate list to generate the presentation candidate list; and candidate display means displays the presentation candidate list, to thereby consider the phrase exhibiting the ambiguity in part of its representation. Accordingly, it is possible to obtain the effect that the operability can be improved by presenting the predictive conversion result intended by the user even in the case where the user selects the representation different from the representation of the word registered in the keyword dictionary (for example, “YOKOHAMA/AISUKOUBOU”) with respect to (“YOKOHAMA/AISUKOUBOU”).

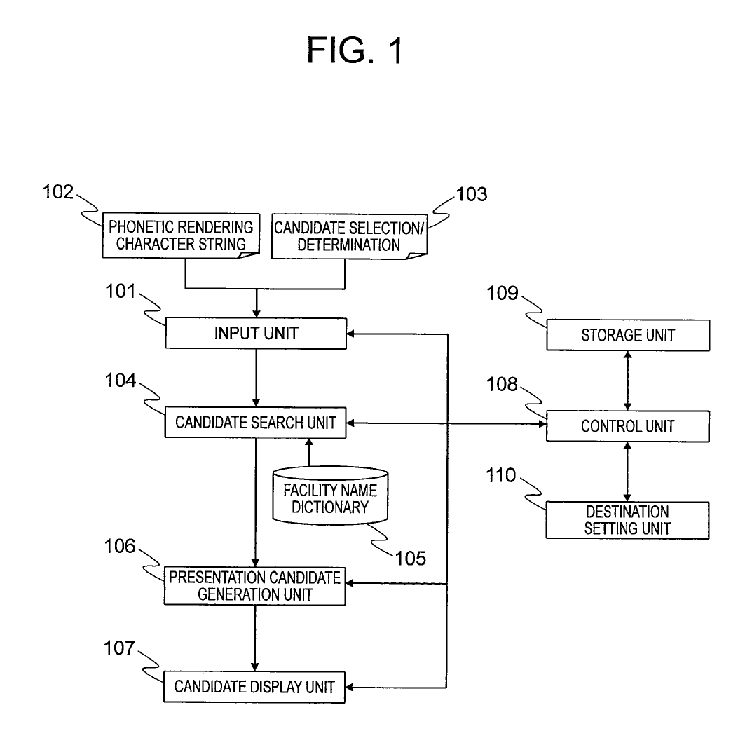

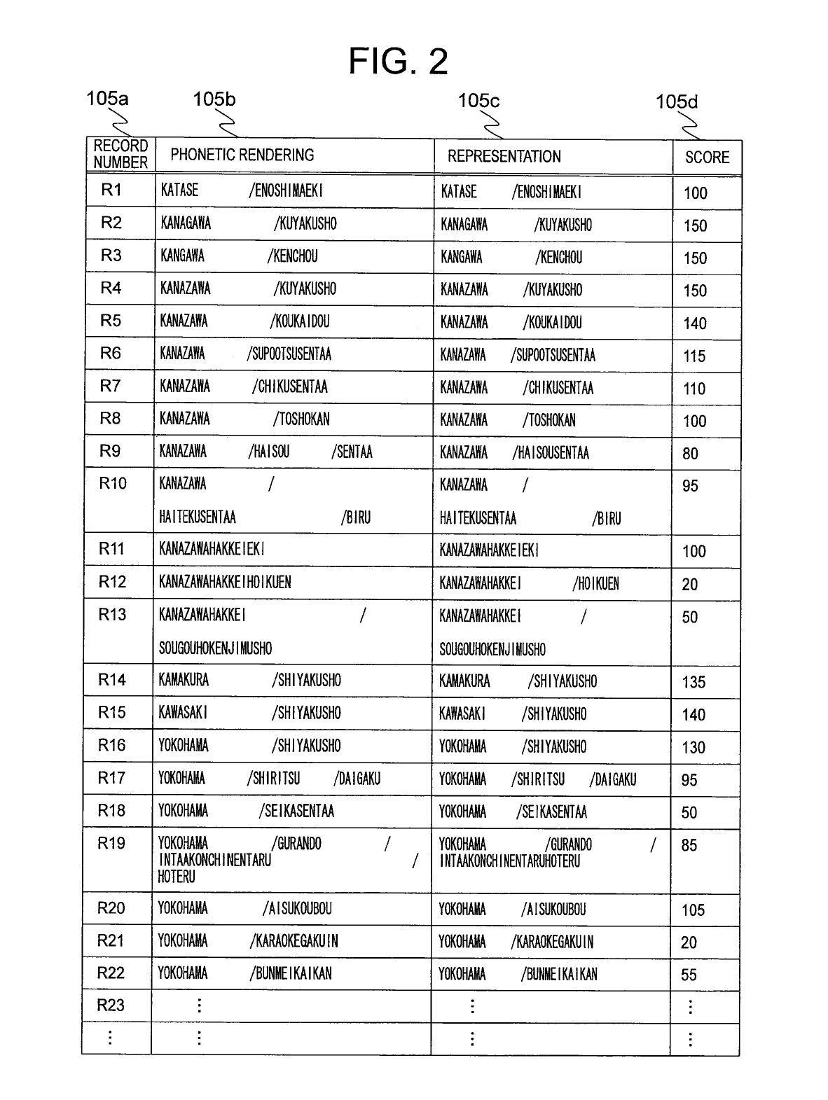

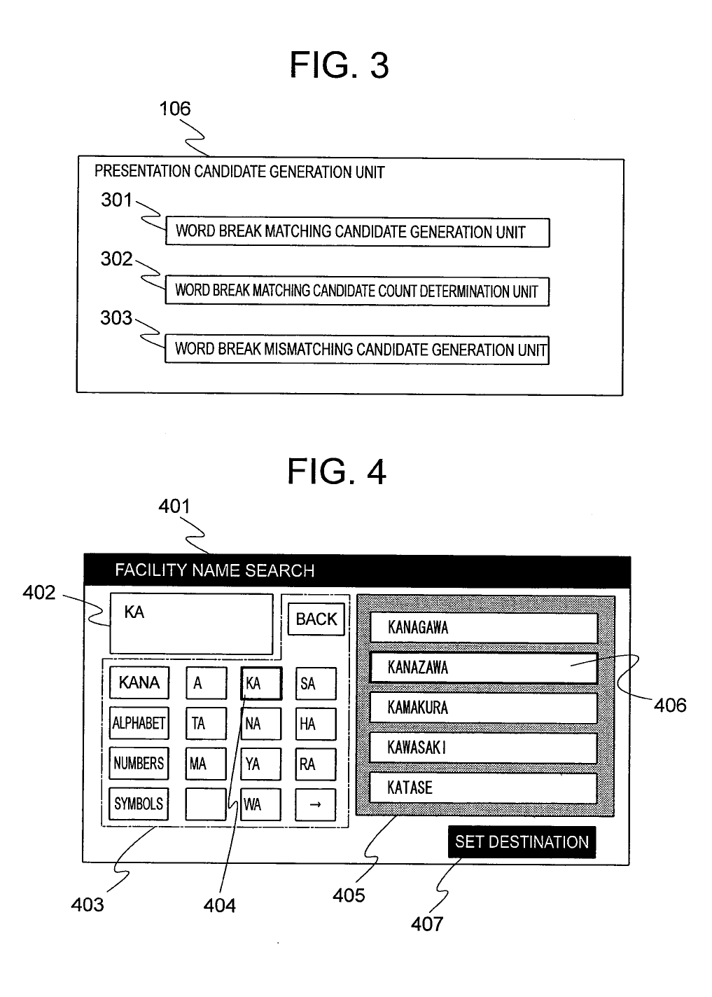

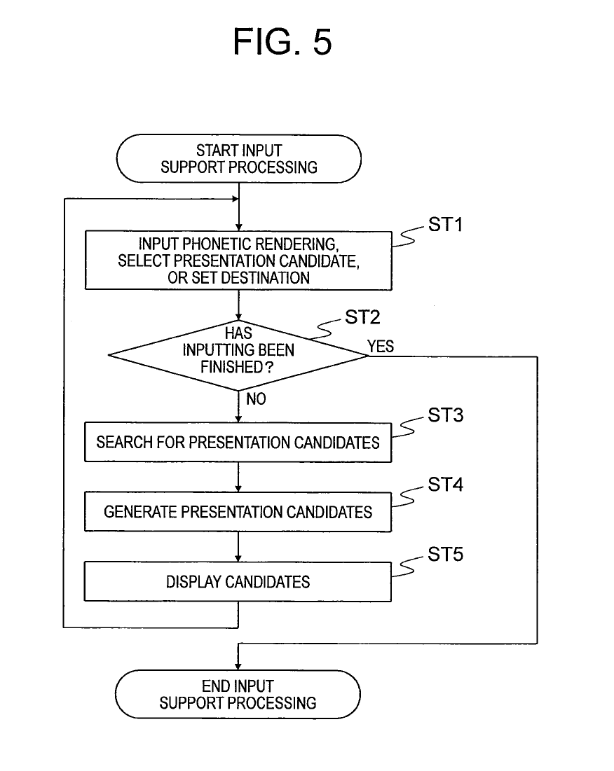

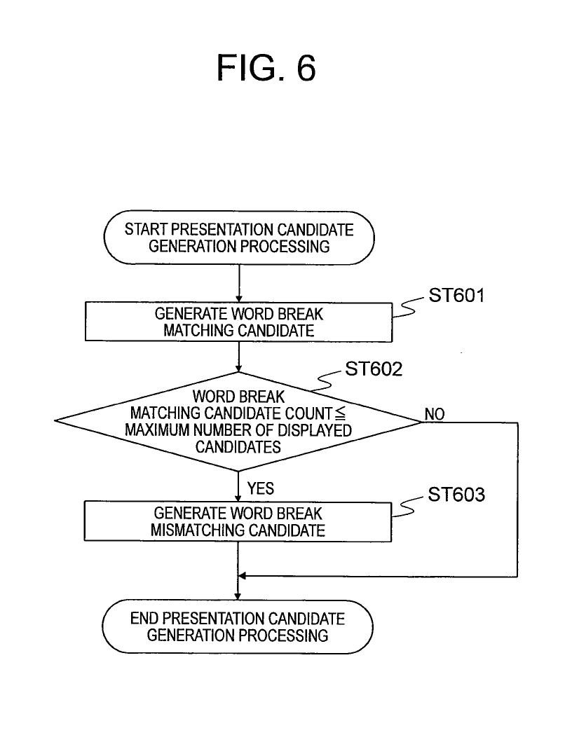

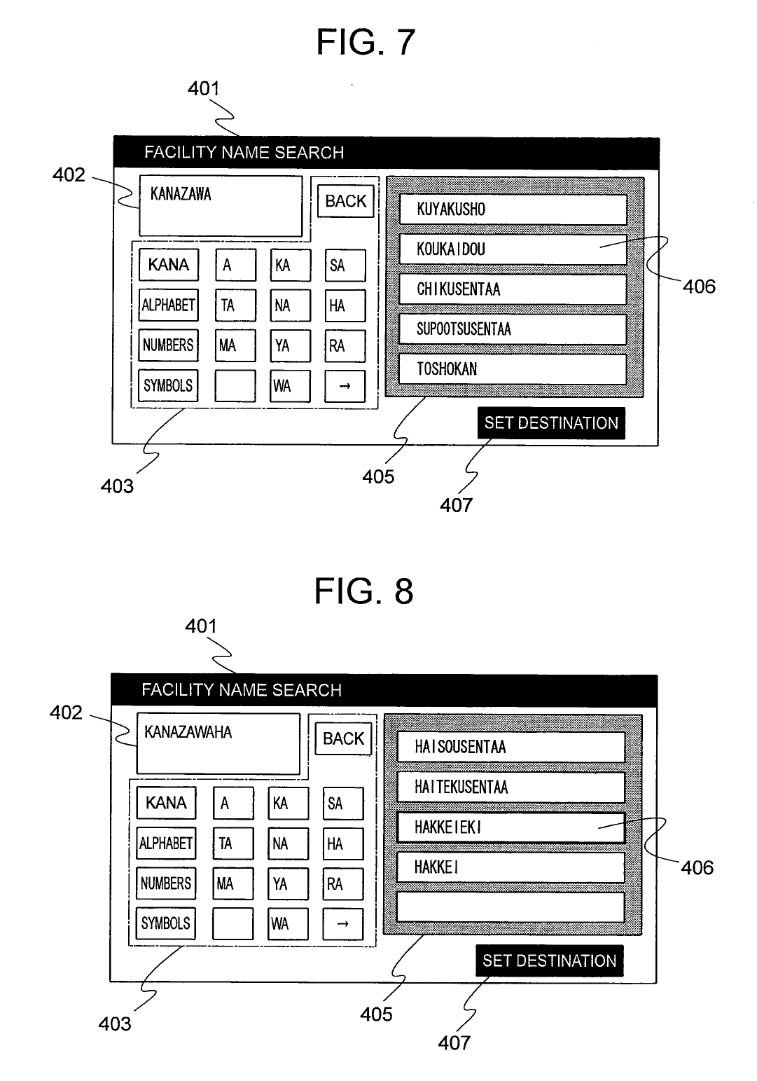

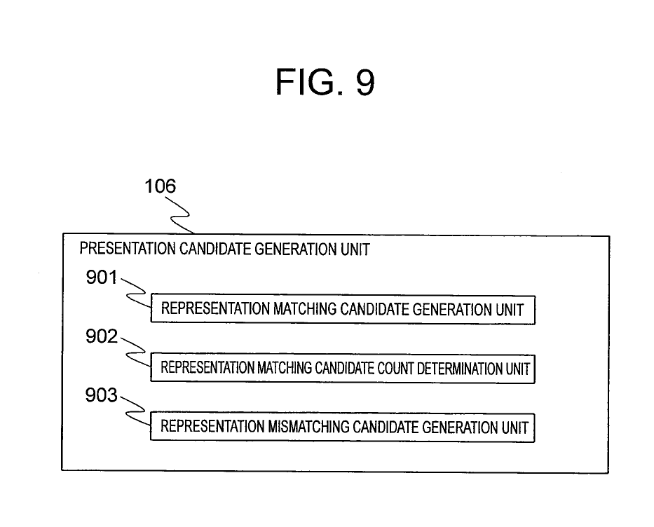

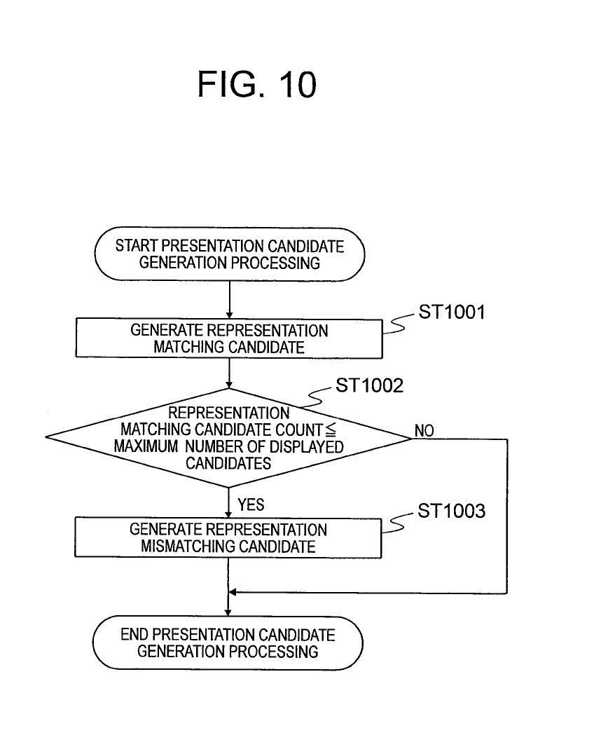

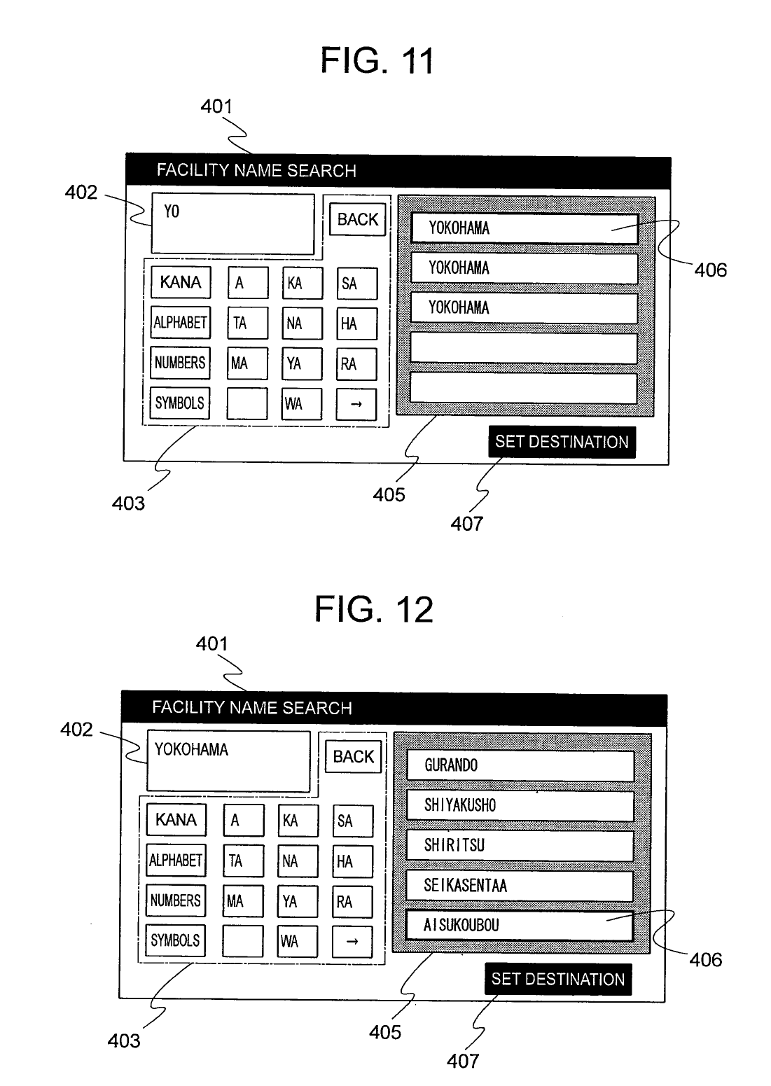

### BRIEF DESCRIPTION OF DRAWINGS

[FIG. 1] A basic configuration diagram according to a first embodiment of the present invention.

[FIG. 2] An explanatory diagram of a facility name dictionary example.

[FIG. 3] A detailed configuration diagram of a presentation candidate generation unit.

[FIG. 4] An explanatory diagram of an input operation screen example (1) according to the first embodiment.

[FIG. 5] A basic processing flowchart of input support processing according to the first embodiment.

[FIG. 6] A detailed flowchart of the presentation candidate generation unit.

[FIG. 7] An explanatory diagram of an input operation screen example (2) according to the first embodiment.

[FIG. 8] An explanatory diagram of an input operation screen example (3) according to the first embodiment.

[FIG. 9] A detailed configuration diagram of a presentation candidate generation unit according to a second embodiment.

[FIG. 10] A detailed flowchart of a presentation candidate generation processing according to the second embodiment.

[FIG. 11] An explanatory diagram of an input operation screen example (1) according to the second embodiment.

[FIG. 12] An explanatory diagram of an input operation screen example (2) according to the second embodiment.

### DESCRIPTION OF EMBODIMENTS

### First embodiment

FIG. 1 is a basic configuration diagram according to a first embodiment of the present invention. Note that, the following description is made by taking as an example of a search for a facility name in destination setting of a car navigation system, but the present invention is not limited to the facility name search of the car navigation system, and can be applied to general equipment in which a keyword for a search is input stepwise by combining predictive conversion and phonetic rendering inputting in a search for a music track on a music player, a search through a telephone book on a cellular telephone, or other such search.

In FIG. 1, an input unit 101 receives a phonetic rendering character string 102 input by a user and a selection result 103 of a presentation candidate from the car navigation system. Those input results are recorded in a storage unit 109 via a control unit 108.

When there is an input of a phonetic rendering character string from the input unit 101, a candidate search unit 104 extracts a phonetic rendering input by the user from the storage unit 109, and searches a facility name dictionary 105 serving as a keyword dictionary to acquire facility name candidates serving as keywords that start with the phonetic rendering character string.

A presentation candidate generation unit 106 generates a presentation candidate list by extracting constituent words from the above-mentioned facility name candidates based on results selected by the user in the process of screening the candidates.

A candidate display unit 107 displays on a monitor the list generated by the presentation candidate generation unit 106 in a list format, to thereby allow the user to select a candidate.

A destination setting unit 110 sets, as a destination, the facility name selected when the user inputs a candidate determination.

FIG. 2 is an example of the facility name dictionary 105. The facility name dictionary 105 stores data including at least “phonetic rendering (105b)” and “representation (105c)”, each of which includes information representing a word break. In this figure, a word break position is expressed by using a single-byte slash (/). Further, the above-mentioned data retains “score (105d)” that is a numerical value indicating a priority as a prediction candidate, and the facility name that is more often used as the destination is given a higher numerical value.

FIG. 3 illustrates a detailed configuration of the presentation candidate generation unit 106. A word break matching candidate generation unit 301 extracts N words selected by the user in the process of screening the candidates, that is, results of selecting the words separated by the word break up to the Nth word, from the storage unit 109, extracts the facility name candidates that start with the above-mentioned N words, and extracts in the score order the (N+1)th words that have not been selected yet by the user to generate the presentation candidate list. A word break matching candidate count determination unit 302 determines whether or not the number of elements within the presentation candidate list generated by the word break matching candidate generation unit 301 exceeds the maximum number of candidates that can be displayed on a screen. A word break mismatching candidate generation unit 303 extracts the facility name whose phonetic rendering matches the N words selected by the user in the process of screening the candidates even if the word break differs therefrom, cuts out a representation character string following the selection result in the process of the screening from within the representation character string of the same candidate, and adds the cut-out representation character string to the presentation candidate list.

Reference numeral 401 of FIG. 4 indicates an example of an operation screen constituting the input unit 101 and the candidate display unit 107, for performing the phonetic rendering inputting and candidate selection through the software keyboard, a numeric keypad, and the like displayed on a touch panel screen. Reference numeral 402 denotes a display portion for displaying the phonetic rendering input by the user and the candidate selection result. Reference numeral 403 denotes a numeric keypad group for inputting the phonetic rendering, on which, for example, each time a “KA” column key 404 is touched, the phonetic rendering is converted in order of the KA column as in “KA”→“KI”→“KU”→“KE”→“KO”. Reference numeral 405 denotes a predictive conversion candidate display area portion for displaying a predictive conversion candidate, which, if a candidate desired by the user is displayed, allows selection thereof by a touch on the corresponding one of individual candidate buttons 406. A destination setting button 407 is used for setting the facility name selected by the user as the destination. Note that, the phonetic rendering inputting and the candidate selection that are performed by direct operations on the screen through the touch panel are taken as examples above, but the selection and the operation may be performed on the item displayed on the screen by using remote control keys or operation keys equipped in a main body. Further, FIG. 4 illustrates the example in which five candidates are presented at maximum, but a scrollbar or a page skip key may be provided to thereby allow 10 or more candidates to be presented at maximum.

Hereinafter, a description is made of processing contents of the present invention by referring to FIGS. 1 to 8 appropriately. The description is made by assuming that the user is attempting to set “KANAZAWAHAKKEIEKI” as the destination in the car navigation system.

FIG. 5 is a basic processing flow of the input support device according to the present invention. In FIG. 5, Step ST1 denotes processing for inputting a phonetic rendering or selecting a presentation candidate. Immediately after a start of input support processing, in other words, in Step ST1 in an initial state, the input unit 101 receives the phonetic rendering character string 102 of the keyword for a search input by the user. Here, “KA” is assumed to have been input as illustrated in the display portion 402 of FIG. 4.

Step ST2 denotes input end determination processing, in which the control unit 108 determines whether or not a destination setting key (407 of FIG. 4) has been operated. If operated, the control unit 108 determines that the inputting has been finished, and if not, executes processing of Step ST3 and the subsequent steps. Here, the phonetic rendering “KA” has been input, and hence the procedure advances to Step ST3 and the subsequent steps.

Step ST3 denotes presentation candidate search processing, in which the candidate search unit 104 searches the facility name dictionary 105 for the facility names that start with the input phonetic rendering character string “KA”. In the case of the facility name dictionary illustrated in FIG. 2, R1 to R15 and the like are retrieved as the facility name candidates. Note that, although not illustrated in FIG. 2, a large number of facility names that start with “KANAGAWA”, “KAMAKURA”, “KAWASAKI”, and “KATASE” are assumed to be registered in positions of/after R23.

Step ST4 denotes presentation candidate generation processing, in which the presentation candidate generation unit 106 generates the presentation candidate list by extracting the constituent words from R1 to R15 retrieved from the facility name dictionary 105 by the candidate search unit 104, based on the results selected by the user in the process of screening the candidates.

FIG. 6 illustrates a detailed flow of the presentation candidate generation processing. In FIG. 6, Step ST601 denotes word break matching candidate generation processing, in which the word break matching candidate generation unit (301 of FIG. 3) extracts the N words, which are the results selected by the user in the screening of the candidates, from the storage unit 109, extracts the facility name candidates that start with the above-mentioned N words, and extracts in the score order the (N+1)th words that have not been selected yet by the user to generate the presentation candidate list. Here, the user has just input the first character of the phonetic rendering and candidate screening results do not exist yet, and hence the first words of the representations of the facility names in the highest positions of the “score” (105c of FIG. 2) are extracted from among all the facility name candidates. Here, five candidates including “KANAGAWA”, “KAMAKURA”, “KAWASAKI”, and “KATASE” are generated as the presentation candidate list.

Step ST602 denotes word break matching candidate count determination processing, in which the word break matching candidate count determination unit (302 of FIG. 3) determines whether or not the number of elements within the presentation candidate list generated above exceeds the maximum number of candidates that can be displayed on the screen. Here, the maximum number of candidates that can be displayed on the screen is five with a word break matching candidate count being five or more, and hence the presentation candidate generation processing is finished without advancing to Step ST603 (described later).

Step ST5 of FIG. 5 denotes candidate display processing, in which the candidate display unit 107 displays the presentation candidate list generated above. Reference numeral 405 of FIG. 4 indicates a state in which those candidates are presented.

Subsequently, the procedure returns to Step ST1 to receive an input from the user. Here, the user is attempting to set “KANAZAWAHAKKEIEKI” as the destination, and hence selects “KANAZAWA” by using the candidate presentation button 406 of FIG. 4. In Step ST2, it is determined that the inputting has not been finished because there is no operation of the destination setting button (407 of FIG. 4), and the procedure advances to Step ST3.

In Step ST3, the candidate search unit 104 searches the facility name dictionary 105 for the facility names that start with the candidate “KANAZAWA” selected by the user. In the case of the facility name dictionary illustrated in FIG. 2, R4 to R13 are retrieved as the facility name candidates.

Subsequently, in Step ST4, based on “KANAZAWA” selected by the user in the screening of the candidates, the presentation candidate generation unit 106 generates the presentation candidate list by extracting the constituent words from R4 to R13 retrieved from the facility name dictionary 105. With regard to the presentation candidate generation processing, a description is made of an operation thereof by referring to the detailed flow of FIG. 6. Step ST601 denotes the word break matching candidate generation processing, in which the word break matching candidate generation unit (301 of FIG. 3) extracts the N words (here, N=1), which are the results selected by the user in the screening of the candidates, from the storage unit 109, extracts the facility name candidates that start with the above-mentioned N words, and extracts in the score order the (N+1)th words that have not been selected yet by the user to generate the presentation candidate list. Here, the candidates are screened to R4 to R10 as the candidates in which “KANAZAWA” selected by the user is the first word, from among which the second words of the representations of the facility names in the highest positions of the “score” (105c of FIG. 2) are extracted. Here, five elements including “KUYAKUSHO”, “KOUKAIDOU”, “CHIKUSENTAA”, “SUPOOTSUSENTAA”, and “TOSHOKAN” are generated as the presentation candidate list.

Step ST602 denotes the word break matching candidate count determination processing, in which the word break matching candidate count determination unit (302 of FIG. 3) determines whether or not the number of elements within the presentation candidate list generated above exceeds the maximum number of candidates that can be displayed on the screen. Here, the maximum number of candidates that can be displayed on the screen being five is equal to the number of elements, and hence the presentation candidate generation processing is finished without advancing to Step ST603 (described later).

Step ST5 of FIG. 5 denotes the candidate display processing, in which the candidate display unit 107 displays the presentation candidate list generated above. The display area portion 405 of FIG. 7 indicates a state in which those candidates are presented.

Subsequently, the procedure returns to Step ST1 to receive an input from the user. Here, the user is attempting to set “KANAZAWAHAKKEIEKI” as the destination, and hence inputs “HA” by using a phonetic rendering input key 403 of FIG. 8. In Step ST2, it is determined that the inputting has not been finished because there is no operation of the destination setting button (407 of FIG. 8), and the procedure advances to Step ST3.

In Step ST3, the candidate search unit 104 searches the facility name dictionary 105 for the facility names that start with the input phonetic rendering character string, here, “KANAZAWAHA” obtained by adding the further input phonetic rendering “HA” to the phonetic rendering “KANAZAWA” of the candidate “KANAZAWA” selected by the user. In the case of the facility name dictionary illustrated in FIG. 2, R9 to R13 are retrieved as the facility name candidates.

Subsequently, in Step ST4, based on “KANAZAWA” selected by the user in the screening of the candidates, the presentation candidate generation unit 106 generates the presentation candidate list by extracting the constituent words from the facility name candidates R9 to R13 retrieved from the facility name dictionary 105. A description is made of an operation thereof by referring to the detailed flow of the presentation candidate generation processing of FIG. 6. Step ST601 denotes the word break matching candidate generation processing, in which the word break matching candidate generation unit (301 of FIG. 3) extracts the N words, which are the results selected by the user in the screening of the candidates, from the storage unit 109, extracts the facility name candidates that start with the above-mentioned N words, and extracts in the score order the (N+1)th words that have not been selected yet by the user to generate the presentation candidate list. Here, the facility name candidates R9 and R10 are extracted as the candidates in which “KANAZAWA” selected by the user is the first word. As a result, the second words of those representations are extracted to generate “HAISOUSENTAA” and “HAITEKUSENTAA” as the presentation candidate list.

Step ST602 denotes word break matching candidate count determination processing, in which the word break matching candidate count determination unit (302 of FIG. 3) determines whether or not the number of elements within the presentation candidate list generated above exceeds the maximum number of candidates that can be displayed on the screen. Here, the maximum number of candidates that can be displayed on the screen is five with the number of elements being two, and hence the procedure advances to Step ST603.

Step ST603 denotes word break mismatching candidate generation processing, in which the word break mismatching candidate generation unit (303 of FIG. 3) extracts the facility name candidates whose phonetic rendering matches the N words selected by the user in the process of screening the candidates even if the word break differs therefrom, cuts out a representation character string following the selection result in the process of the screening from within the representation character string of the same candidate, and adds the cut-out representation character string to the presentation candidate list. Here, the facility names R11, R12, and R13 are extracted. “HAKKEIEKI” obtained by excluding “KANAZAWA” from the representation of the leading word of R11 is added to the presentation candidate list, and “HAKKEI” obtained by excluding “KANAZAWA” from the leading word of R12 and R13 is also added to the presentation candidate list. The presentation candidate generation processing is finished here, and the procedure advances to the subsequent step (ST5 of FIG. 5).

Step ST5 of FIG. 5 denotes candidate display processing, in which the candidate display unit 107 displays the presentation candidate list generated above. Reference numeral 405 of FIG. 8 indicates a state in which those candidates are presented. In addition, the procedure returns to Step ST1, in which the user selects “HAKKEIEKI” (406 of FIG. 8). In addition, after repeating the processing from Step ST2 to Step ST5, the user operates “SET DESTINATION” (407 of FIG. 8) again in Step ST1, and the input support processing is finished after Step ST2.

As described above, it is possible to obtain an effect that operability in predictive conversion can be improved by considering ambiguity of a word break in the predictive conversion to present the prediction candidates expected by the user even if the break pattern of the word (“KANAZAWAHAKKEIEKI” without a break) which is registered in the dictionary differs from the break pattern of the word (“KANAZAWA/HAKKEIEKI”) which is employed when the user inputs the word.

### Second Embodiment

FIG. 9 is a detailed configuration diagram of the presentation candidate generation unit 106 according to a second embodiment of the present invention. A representation matching candidate generation unit 901 extracts results of selecting N words selected by the user in the process of screening the candidates from the storage unit 109, extracts the facility name candidates that start with the above-mentioned N words, and extracts in the score order the (N+1)th words that have not been selected yet by the user to generate the presentation candidate list. A representation matching candidate count determination unit 902 determines whether or not the number of elements within the presentation candidate list generated above exceeds the maximum number of candidates that can be displayed on a screen. A representation mismatching candidate generation unit 903 extracts the facility name candidates whose phonetic rendering matches the N words selected by the user in the process of screening the candidates but whose representation of the word partially differs therefrom, extracts in the score order the (N+1)th words that have not been selected yet by the user, and adds the extracted (N+1)th words to the presentation candidate list. The other configuration is the same as that of the first embodiment, and hence the descriptions of the other means are omitted.

FIG. 10 illustrates a detailed flow of presentation candidate generation processing according to the second embodiment of the present invention. The other steps are the same as those of the first embodiment, and hence details thereof are omitted. Hereinafter, a description is made of processing contents of the second embodiment of the present invention by referring to FIG. 1, FIG. 2, FIG. 5, and FIG. 9 to FIG. 12 appropriately. The description is made by assuming that the user is attempting to set “YOKOHAMAAISUKOUBOU” as the destination. Immediately after the start of the input support processing, in other words, in Step ST1 (FIG. 5) in the initial state, the input unit 101 receives the phonetic rendering character string 102 of the keyword for a search input by the user. Here, “YO” is assumed to have been input as illustrated in the display portion 402 of FIG. 11.

Step ST2 (FIG. 5) denotes the input end determination processing, in which the control unit 108 determines whether or not the destination setting key (407 of FIG. 11) has been operated. If operated, the control unit 108 determines that the inputting has been finished, and if not, executes the processing of Step ST3 and the subsequent steps. Here, the phonetic rendering “YO” has been input, and hence the procedure advances to Step ST3 and the subsequent steps.

Step ST3 denotes the presentation candidate search processing, in which the candidate search unit 104 searches the facility name dictionary 105 for the facility names that start with the input phonetic rendering character string “YO”. In the case of the facility name dictionary illustrated in FIG. 2, R16 to R22 are retrieved as the facility name candidates.

Step ST4 denotes the presentation candidate generation processing, in which the presentation candidate generation unit 106 generates the presentation candidate list by extracting the constituent words from R16 to R22 retrieved from the facility name dictionary 105 by the candidate search unit 104, based on the results selected by the user in the process of screening the candidates. Step ST1001 of FIG. 10 denotes representation matching candidate generation processing, in which the representation matching candidate generation unit (901 of FIG. 9) extracts the N words being the results selected by the user in the screening of the candidates from the storage unit 109, extracts the facility name candidates that start with the above-mentioned N words, and extracts in the score order the (N+1)th words that have not been selected yet by the user to generate the presentation candidate list. Here, the user has just input the first character of the phonetic rendering and the candidate screening results do not exist yet, and hence the first words of the representations of the facility names in the highest positions of the “score” (105c of FIG. 2) are extracted from among all the facility name candidates. Here, “YOKOHAMA”, “YOKOHAMA”, and “YOKOHAMA” are generated from R16 to R22 as the presentation candidate list.

Step ST1002 denotes representation matching candidate count determination processing, in which the representation matching candidate count determination unit (902 of FIG. 9) determines whether or not the number of elements within the presentation candidate list generated above is equal to or larger than the maximum number of candidates that can be displayed on the screen. Here, the maximum number of candidates that can be displayed on the screen is five with the number of elements being three, and hence the procedure advances to Step ST1003.

Step ST1003 denotes representation mismatching candidate generation processing, in which the representation mismatching candidate generation unit (903 of FIG. 9) extracts the facility name candidates whose phonetic rendering matches the N words selected by the user in the process of screening the candidates but whose representation of the word partially differs therefrom, extracts in the score order the (N+1)th words that have not been selected yet by the user, and adds the extracted (N+1)th words to the presentation candidate list. Here, the user has just input the first character of the phonetic rendering without the existence of the candidate screening results, and hence there is no addition to the presentation candidate list in this step because the first words are extracted as the presentation candidate list from all the facility name candidates in Step ST1001. The presentation candidate generation processing is finished here, and the procedure advances to the subsequent step (ST5 of FIG. 5).

Step ST5 of FIG. 5 denotes candidate display processing, in which the candidate display unit 107 displays the presentation candidate list generated above. Reference numeral 405 of FIG. 11 indicates a state in which those candidates are presented.

Subsequently, the procedure returns to Step ST1 to receive an input from the user. Here, it is assumed that the user is attempting to set “YOKOHAMAAISUKOUBOU” as the destination but has selected “YOKOHAMA” (406 of FIG. 11) without noticing that the formal name is “YOKOHAMA”. In Step ST2, it is determined that the inputting has not been finished because there is no operation of the destination setting button (407 of FIG. 11), and the procedure advances to Step ST3.

In Step ST3, the candidate search unit 104 searches the facility name dictionary 105 for the facility names that start with the input phonetic rendering character string, here, the phonetic rendering “YOKOHAMA” of “YOKOHAMA” selected by the user. In the case of the facility name dictionary illustrated in FIG. 2, R16 to R22 are retrieved as the facility name candidates.

Subsequently, in Step ST4, based on “YOKOHAMA” selected by the user in the screening of the candidates, the presentation candidate generation unit 106 generates the presentation candidate list by extracting the constituent words from R16 to R22 retrieved from the facility name dictionary. A description is made of an operation thereof by referring to the detailed flow of the presentation candidate generation processing of FIG. 10. Step ST1001 denotes the representation matching candidate generation processing, in which the representation matching candidate generation unit (901 of FIG. 9) extracts the N words being the results selected by the user in the screening of the candidates from the storage unit 109, extracts the facility name candidates that start with the above-mentioned N words, and extracts in the score order the (N+1)th words that have not been selected yet by the user to generate the presentation candidate list. Here, the candidates are screened to R16 to R18 as the candidates in which “YOKOHAMA” selected by the user is the first word, from among which the second words of the representations of the facility names in the highest positions of the “score” (105c of FIG. 2) are extracted. Here, “SHIYAKUSHO”, “SHIRITSU”, and “SEIKASENTAA” are generated as the presentation candidate list.

Step ST1002 denotes representation matching candidate count determination processing, in which the representation matching candidate count determination unit (1002 of FIG. 10) determines whether or not the number of elements within the presentation candidate list generated above is smaller than the maximum number of candidates that can be displayed on the screen. Here, the maximum number of candidates that can be displayed on the screen is five with the number of elements being three, and hence the procedure advances to Step ST1003.

Step ST1003 denotes representation mismatching candidate generation processing, in which the representation mismatching candidate generation unit (903 of FIG. 9) extracts the facility name candidates whose phonetic rendering matches the N words selected by the user in the process of screening the candidates but whose representation of the word partially differs therefrom, extracts in the score order the (N+1)th words that have not been selected yet by the user, and adds the extracted (N+1)th words to the presentation candidate list. Here, the facility names of R19 to R22 are extracted, and “GURANDO, “AISUKOUBOU”, “KARAOKEGAKUIN”, and “BUNMEIKAIKAN” being the second words thereof are added to the presentation candidate list in the score order. The presentation candidate generation processing is finished here, and the procedure advances to the subsequent step (ST5 of FIG. 5).

Step ST5 of FIG. 5 denotes candidate display processing, in which the candidate display unit 107 displays the presentation candidate list generated above. The display area portion 405 of FIG. 12 indicates a state in which those candidates are presented. In addition, the procedure returns to Step ST1, in which the user selects “AISUKOUBOU” (406 of FIG. 12). In addition, after repeating the processing from Step ST2 to Step ST5, the user operates “SET DESTINATION” (407 of FIG. 8) again in Step ST1, and the input support processing is finished after Step ST2.

As described above, it is possible to obtain an effect that the operability can be improved by considering a phrase exhibiting ambiguity in part of its representation to present a predictive conversion result intended by the user even in the case where the user selects the representation (“YOKOHAMA/AISUKOUBOU”) different from the representation of the word (“YOKOHAMA/AISUKOUBOU”) registered in the dictionary.

Note that, the presentation candidate generation unit can be configured by combining both the generation of the presentation candidate list based on the matching/mismatching of the word break according to the first embodiment and the generation of the presentation candidate list based on the matching/mismatching of the representation of the word according to the second embodiment, and can be configured to perform the keyword selection processing based on the matching/mismatching of the representation of the word after the keyword selection processing based on the matching/mismatching of the word break or perform the processing by the reverse procedure. With such a configuration, it is possible to obtain an input support device for a search keyword which is capable of handling the ambiguity of the word break and the ambiguity in the representation of the word.

### INDUSTRIAL APPLICABILITY

The present invention can be applied to the general equipment in which a keyword for a search is input stepwise by combining the predictive conversion and the phonetic rendering inputting. In particular, the present invention is highly effective for the facility name search of the car navigation system, the search for a music track on the music player, and the search through the telephone book on the cellular telephone, or can be highly effectively applied to the equipment including no keyboard such as a display device for FA.

### REFERENCE SIGNS LIST

101 input unit, 102 phonetic rendering character string, 103 selection result of a presentation candidate, 104 candidate search unit, 105 facility name dictionary, 106 presentation candidate generation unit, 107 candidate display unit, 108 control unit, 109 storage unit, 110 destination setting unit, 301 word break matching candidate generation unit, 302 word break matching candidate count determination unit, 303 word break mismatching candidate generation unit, 901 representation matching candidate generation unit, 902 representation matching candidate count determination unit, 903 representation mismatching candidate generation unit

1-2. (canceled)

3. An input support device, comprising:
a keyword dictionary for storing a keyword including one or more words;
candidate search means for searching entries within the keyword dictionary by using a search key including one or more words specified based on a user operation;
presentation candidate generation means for generating a presentation candidate list based on search results from the candidate search means by extracting a word break mismatching presentation candidate from the keywords whose word break does not match that of the specified search key including the one or more words and which start with the specified search key including the one or more words; and
candidate display means for displaying the presentation candidate list generated by the presentation candidate generation means.

4. An input support device according to claim 3, wherein:
the presentation candidate generation means extracts the word break mismatching presentation candidate and a word break matching presentation candidate to generate the presentation candidate list by prioritizing the word break matching presentation candidate; and
the word break matching presentation candidate is extracted from the keywords whose word break matches that of the specified search key including the one or more words and which start with the specified search key including the one or more words.

5. An input support device according to claim 4, wherein the presentation candidate generation means determines whether or not a number of the word break matching presentation candidates is less than a maximum number of candidates that can be displayed on a screen, and when the number of the word break matching presentation candidates is less than the maximum number of candidates that can be displayed on the screen, adds the word break mismatching presentation candidate to the word break matching presentation candidate to generate the presentation candidate list.

6. An input support device according to claim 3, wherein:
the keyword dictionary stores phonetic renderings and representations of the words; and
the candidate search means searches the entries within the keyword dictionary by using the search key including the phonetic renderings and the representations of the one or more words specified based on the user operation.

7. An input support device, comprising:
a keyword dictionary for storing a keyword including phonetic renderings and representations of one or more words;
candidate search means for searching entries within the keyword dictionary by using a search key including the phonetic renderings of one or more words specified based on a user operation;
presentation candidate generation means for generating a presentation candidate list based on search results from the candidate search means by extracting a representation mismatching presentation candidate from the keywords any one of the representations of which does not match that of the specified one or more words and which start with a phonetic rendering obtained by combining the phonetic renderings of the specified one or more words; and
candidate display means for displaying the presentation candidate list generated by the presentation candidate generation means.

8. An input support device according to claim 7, wherein:
the presentation candidate generation means extracts the representation mismatching presentation candidate and a representation matching presentation candidate to generate the presentation candidate list by prioritizing the representation matching presentation candidate; and
the representation matching presentation candidate is extracted from the keywords any one of the representations of which match that of the specified one or more words and which start with a phonetic rendering obtained by combining the phonetic renderings of the specified one or more words.

9. An input support device according to claim 8, wherein the presentation candidate generation means determines whether or not a number of the representation matching presentation candidates is less than a maximum number of candidates that can be displayed on a screen, and when the number of the representation matching presentation candidates is less than the maximum number of candidates that can be displayed on the screen, adds the representation mismatching presentation candidate to the representation matching presentation candidate to generate the presentation candidate list.

10. An input support device, which presents, when a phonetic rendering is input, words of a predictive keyword, which is obtained by separating a keyword that starts with the phonetic rendering by a word break, as candidates in units of breaks and which allows the keyword to be input hierarchically while selecting presented candidate words, the input support device comprising:
input means for receiving a phonetic rendering character string input by a user or a selection result of a presentation candidate word;
storage means for recording the input phonetic rendering character string or the selection result of the presentation candidate word as a phonetic rendering character string, which have been received by the input means;
a keyword dictionary comprising a phonetic rendering, a break of the phonetic rendering, a representation corresponding to the phonetic rendering, and a break of the representation corresponding to the break of the phonetic rendering;
candidate search means for searching, based on a phonetic rendering input by the user, the storage means for a phonetic rendering character string that follows the input phonetic rendering, and searching the keyword dictionary for presentation candidates based on the retrieved phonetic rendering character string;
word break matching candidate generation means for generating a presentation candidate list whose word break matches the selection result selected by the user in process of screening candidates based on search results from the candidate search means;
word break matching candidate count determination means for determining whether or not a number of elements within the presentation candidate list generated above is less than a maximum number of candidates that can be displayed on a screen;
word break mismatching candidate generation means for extracting, when a result from the word break matching candidate count determination means is less than the maximum number of candidates that can be displayed, a keyword candidate whose phonetic rendering matches that of the selection result selected by the user in the process of screening the candidates even if the word break differs therefrom, adding the keyword candidate to a word break matching presentation candidate list to generate the presentation candidate list; and
candidate display means for displaying the presentation candidate list,
wherein the candidate search means further selects a candidate word from the presentation candidate list displayed by the candidate display means, and stores the candidate word in the storage means.

11. An input support device, which presents, when a phonetic rendering is input, words of a predictive keyword, which is obtained by separating a keyword that starts with the phonetic rendering by a word break, as candidates in units of breaks and which allows the keyword to be input hierarchically while selecting presented candidate words, the input support device comprising:
input means for receiving a phonetic rendering character string input by a user or a selection result of a presentation candidate word;
storage means for recording the input phonetic rendering character string or the selection result of the presentation candidate word as a phonetic rendering character string, which have been received by the input means;
a keyword dictionary comprising a phonetic rendering, a break of the phonetic rendering, a representation corresponding to the phonetic rendering, and a break of the representation corresponding to the break of the phonetic rendering;
candidate search means for searching, based on a phonetic rendering input by the user, the storage means for a phonetic rendering character string that follows the input phonetic rendering, and searching the keyword dictionary for presentation candidates based on the retrieved phonetic rendering character string;
representation matching candidate generation means for generating a presentation candidate list whose representation matches the selection result selected by the user in process of screening candidates based on search results from the candidate search means;
representation matching candidate count determination means for determining whether or not a number of elements within the presentation candidate list generated above is less than a maximum number of candidates that can be displayed on a screen;
representation mismatching candidate generation means for extracting, when a result from the representation matching candidate count determination means is less than the maximum number of candidates that can be displayed, a presentation candidate whose phonetic rendering matches that of the selection result selected by the user in the process of screening the candidates but whose representation of the word partially differs therefrom, extracting words following the selection result in a score order, adding the words to a representation matching presentation candidate list to generate the presentation candidate list; and
candidate display means for displaying the presentation candidate list, wherein the candidate search means further selects a candidate word from the presentation candidate list displayed by the candidate display means, and stores the candidate word in the storage means.
